(19) United States
(12) Patent Application Publication
(10) Pub. No.: US 2006/0117972 A1
(43) Pub. Date: Jun. 8, 2006

(54) Printing module, and printing machine provided with such printing module

(76) Inventor: Antonie Selis van de Bovenkamp, Renkum (NL)

Correspondence Address: BIRCH STEWART KOLASCH & BIRCH, PO BOX 747, FALLS CHURCH, VA, 22040-0747, US

(21) Appl. No.: 10/537,099

(22) PCT Filed: Dec. 2, 2003
(86) PCT No.: PCT/NL03/00848

§ 371 Date: Dec. 29, 2005

(30) Foreign Application Priority Data
Dec. 2, 2002 (NL) 1022048

(51) Int. Cl. B41F 5/00

(52) U.S. Cl. 101/216

(57) ABSTRACT

A printing module provided with an impression roller, a plate cylinder assembly (22), an anilox roller (33) and a doctor roller, the impression roller (13) being rotatably bearing-mounted in a main frame, the plate cylinder being rotatably bearing-mounted in a first subframe (15) which is movably connecte, with the main frame for the purpose of the positioning of the plate cylinder relative to the impression roller, while the anilox roller and the doctor ro: are rotatably bearing-mounted in a second subframe (31) which is movably connected with the main frame for the purpose of the positioning of the anilc roller relative to the plate cylinder, displaceable connections being so designed that a positioning change of the plate cylinder relative to the impression roller does not affect the positioning of the anilox roller relat: to the plate cylinder and that a positioning change of the anilox roller relative to the plate cylinder does not affect the positioning of the plate cylinder relative to the impression roller.

This invention relates to a printing module provided with an impression roller, a plate cylinder assembly comprising a plate cylinder which is provided with a print image and which, in use, with interposition of a substrate to be printed, abuts against the impression roller, an anilox roller and a doctor roller, the doctor roller taking up ink from an ink reservoir, the anilox roller being arranged between the doctor roller and the plate cylinder, such that a desired amount of ink is taken off the doctor roller by the anilox roller and transferred to the plate cylinder, the position of the plate cylinder being settable, the position of the anilox roller being settable, and the impression roller being rotatably bearing-mounted in a main frame.

Such an apparatus is known from U.S. Pat. No. 4,878,427, the content of which is to be considered inserted herein. This known apparatus involves a single frame in which the doctor roller, the anilox roller and the impression roller are rotatable bearing-mounted. The relative positions of these three rollers are therefore fixed in the known apparatus. The plate cylinder assembly of the known apparatus is provided, at the free ends thereof, with supporting rings each resting on two semicircular supports which are connected with the frame. The positions of the four semicircular supports are settable. The drawback of the known apparatus is that with the adjustment of supports, in each case both the distance between the impression roller and the plate cylinder and the distance between the anilox roller and the plate cylinder is affected. Since, as is also stated in the publication mentioned, setting the relative positions of the plate cylinder, the impression roller and the anilox roller is of critical importance to the quality of the printed matter, it is preferred that a proper setting, once made, is not lost. In the known apparatus, this is the case in that, when, for instance, the distance between the impression roller and the plate cylinder is to be set anew, the setting of the distance between the plate cylinder and the anilox roller needs to take place anew as well because the setting of one distance affects the setting of the other distance.

The invention contemplates a solution to these problems and to that end provides a printing module of the type described in the opening paragraph hereof which is characterized, according to the invention, in that the plate cylinder is rotatably bearing-mounted in a first subframe which is movably connected to the main frame for the purpose of the positioning of the plate cylinder relative to the impression roller, while the anilox roller and the doctor roller are rotatably bearing-mounted in a second subframe which is movably connected to the main frame for the purpose of the positioning of the anilox roller relative to the plate cylinder, movable connections being so designed that a positioning change of the plate cylinder relative to the impression roller does not affect the positioning of the anilox roller relative to the plate cylinder and that a positioning change of the anilox roller relative to the plate cylinder does not affect the positioning of the plate cylinder relative to the impression roller.

It will be clear that the movable connection between the first subframe and the main frame and the movable connection between the second subframe and the main frame can be designed in different ways. Essential is that a positioning change of the plate cylinder relative to the impression roller does not affect the positioning of the anilox roller relative to the plate cylinder and that a positioning change of the anilox roller relative to the plate cylinder does not affect the positioning of the plate cylinder relative to the impression roller. Since according to the proposal of the invention the settings of the two distances have been uncoupled from each other, setting has become much simpler. When, for instance, a thicker substrate web is passed through, only one distance setting needs to be changed, viz. that between the plate cylinder and the impression roller. In the known apparatus, this would inevitably have as a consequence that also the distance between the anilox roller and the plate cylinder must be set anew. This latter setting activity is eliminated in the apparatus according to the invention under these circumstances. Also when the ink transfer between the anilox roller and the plate cylinder is no longer satisfactory and the distance between the anilox roller and the plate cylinder needs to be set anew, these setting activities do not have as a consequence that additionally the distance between the plate cylinder and the impression roller needs to be set anew. Not only is costly setting time, and hence loss of production time, saved in this way, but moreover, due to the uncoupling of the setting of the two distances, setting is rendered simpler. As a consequence, a proper setting is achieved much faster and a proper print image can be obtained with a minimum of waste.

According to a further elaboration, the plate cylinder assembly is provided with a stop surface, while the second subframe is provided with a stop which, in use, abuts against the stop surface of the plate cylinder. It is preferred here that the stop is settable relative to the second subframe or that the stop surface is settable relative to the plate cylinder. With such a settable stop, the distance between the anilox roller and the plate cylinder can be simply varied without the setting of the stop affecting the set distance between the impression roller and the plate cylinder.

According to a still further elaboration of the invention, the movable connection between the second subframe and the main frame is realized via a movable connection between the second subframe and the first subframe. In this way, it is ensured that an adjustment of the distance between the plate cylinder and the impression roller does not have any influence on the distance between the plate cylinder and the anilox roller, since for adjusting that distance, the first subframe is moved relative to the main frame. The distance between the plate cylinder and the anilox roller is determined by the parts mounted on the first subframe, which first subframe is moved as a whole for setting the distance between the plate cylinder and the impression roller. When the distance between the anilox roller and the plate cylinder is to be set, the second subframe is moved relative to the first subframe. Accordingly, this does not involve displacement of the first subframe relative to the main frame. The setting of the two distances is therefore completely uncoupled.

According to another further elaboration of the invention, the movable connection between the first subframe and the main frame is a connection pivotable about a first pivot. According to a yet farther elaboration, the movable connection between the second subframe and the main frame or, in the still further elaboration mentioned, the first subframe, is a connection pivotable about a second pivot. Such pivotable connections are stable and maintenance-friendly.

The invention further relates to a printing machine provided with at least one printing module according to the invention.

Further elaborations of the invention are described in the subclaims and will be further claimed hereinafter on the basis of an exemplary embodiment, with reference to the drawings.

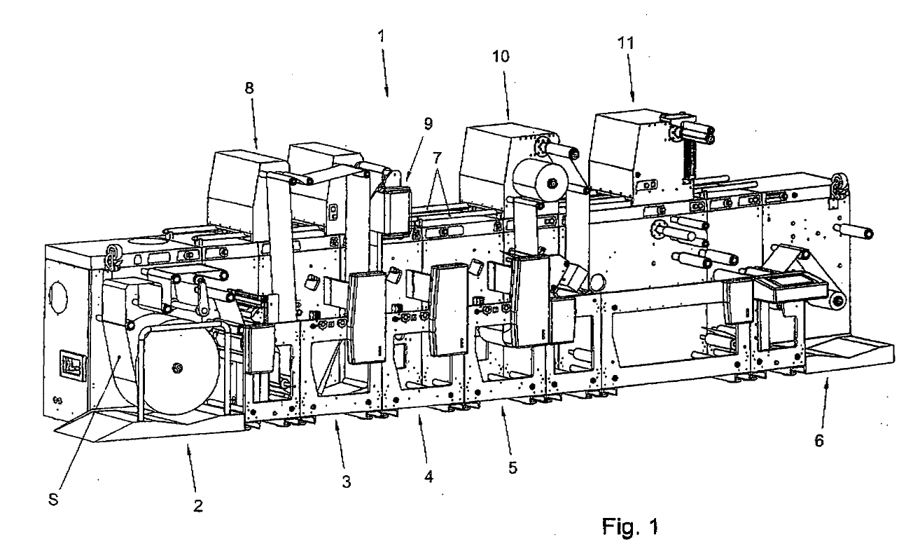

FIG. 1 shows a perspective view of a printing machine provided with a number of printing modules;

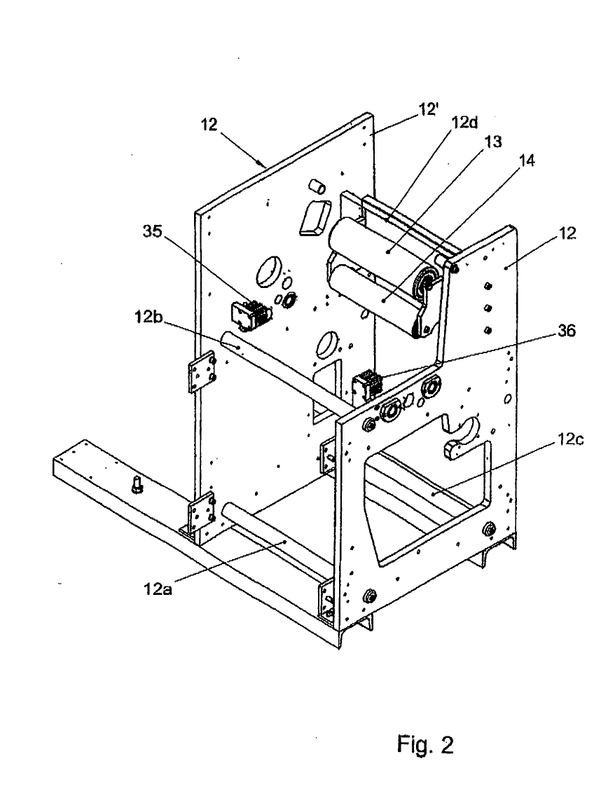

FIG. 2 shows a perspective view of a main frame of the printing module, with the impression roller and a guide roller mounted in the main frame;

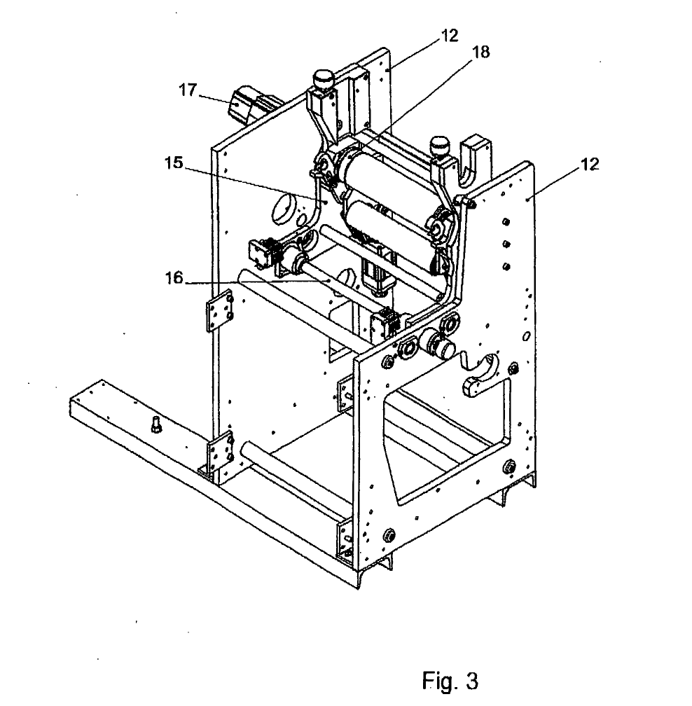

FIG. 3 shows a similar perspective view to FIG. 2, with a first subframe mounted pivotably in the main frame;

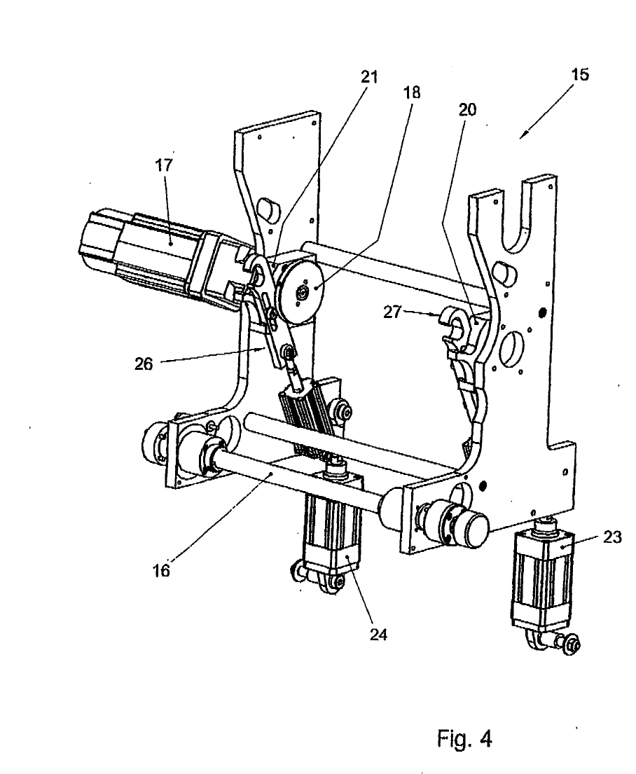

FIG. 4 shows a perspective view of the first subframe separately from the main frame;

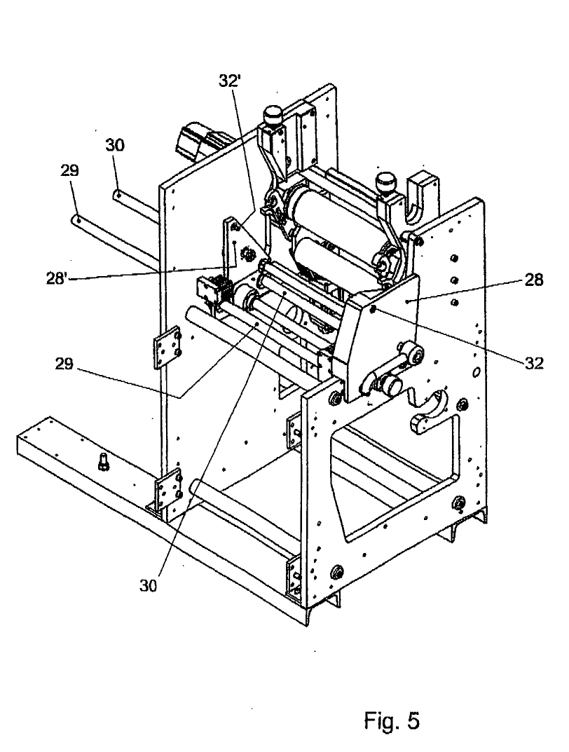

FIG. 5 shows a similar perspective view to FIG. 2, with a sliding frame arranged in the main frame;

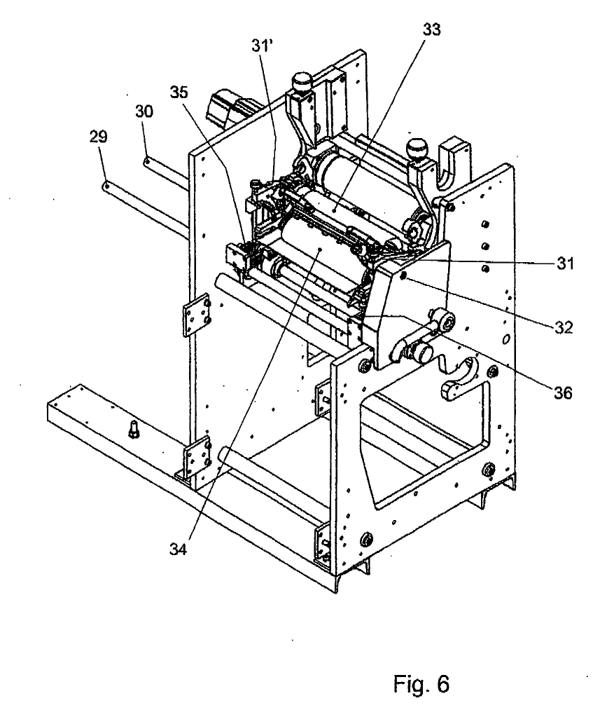

FIG. 6 shows a similar perspective view to FIG. 2, where the ink application assembly provided with the second subframe is pivotably included in the sliding frame;

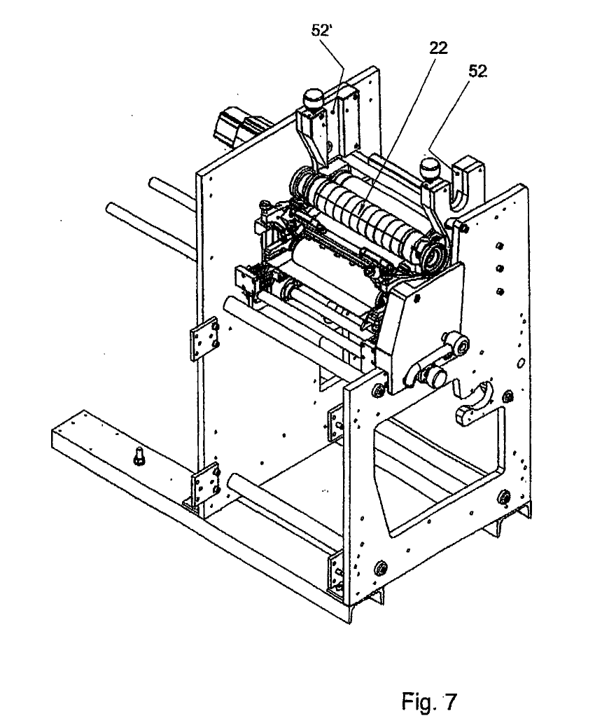

FIG. 7 shows a similar perspective view to FIG. 2, with a plate cylinder assembly mounted in the first subframe;

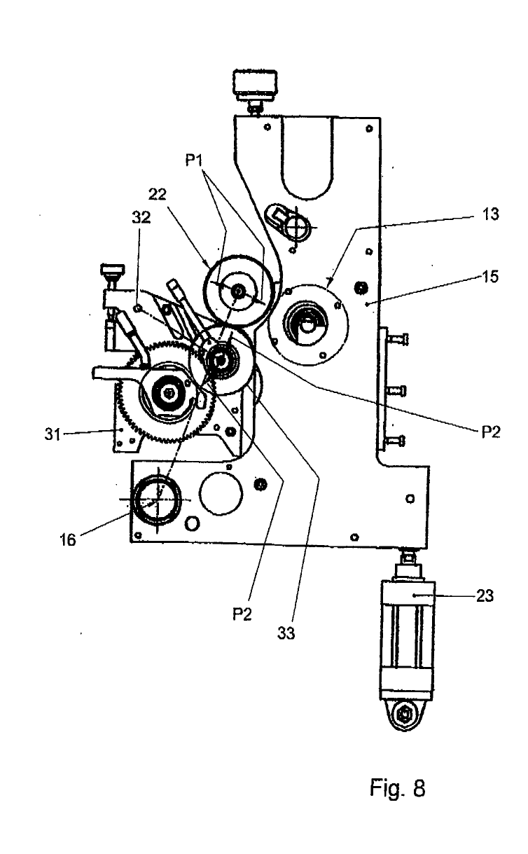

FIG. 8 shows a side elevation of the first subframe and the second subframe with an ink application assembly included therein;

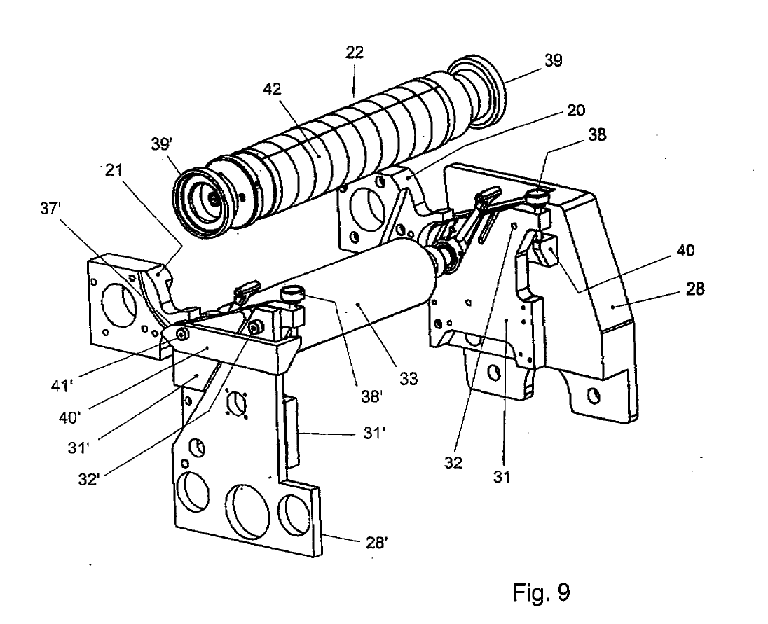

FIG. 9 shows a perspective view of the sliding frame and the second subframe pivotably included therein, with the plate cylinder represented as hanging above the receiving units;

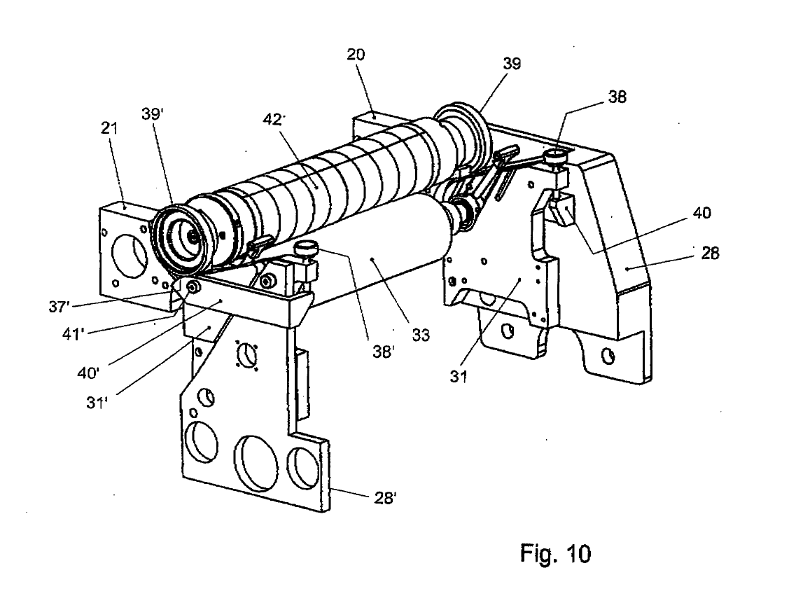

FIG. 10 shows a similar perspective view to FIG. 9, with the plate cylinder included in the receiving units;

FIG. 11 shows a side elevation of the second subframe and the plate cylinder in operative position;

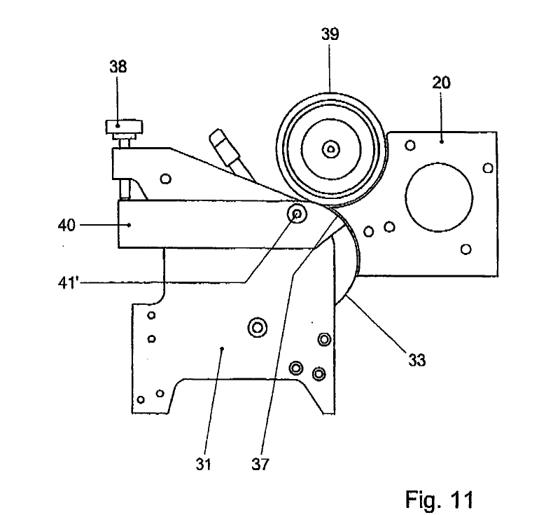

FIG. 12 shows a perspective view of the plate cylinder assembly;

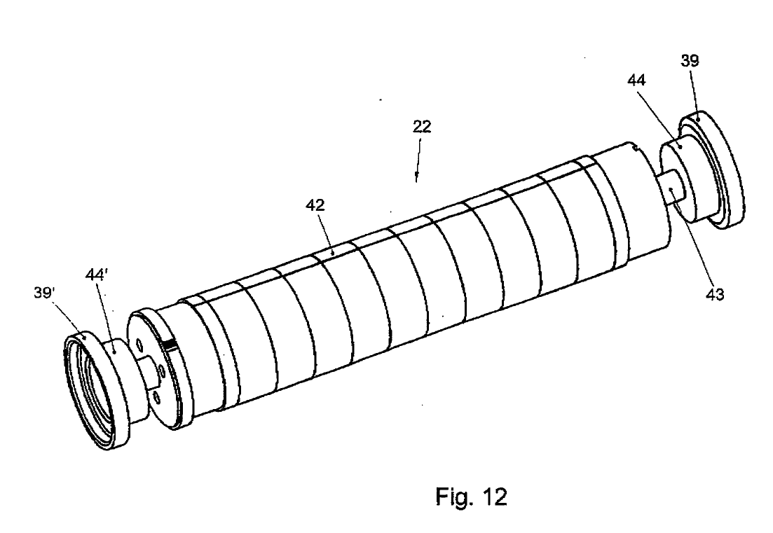

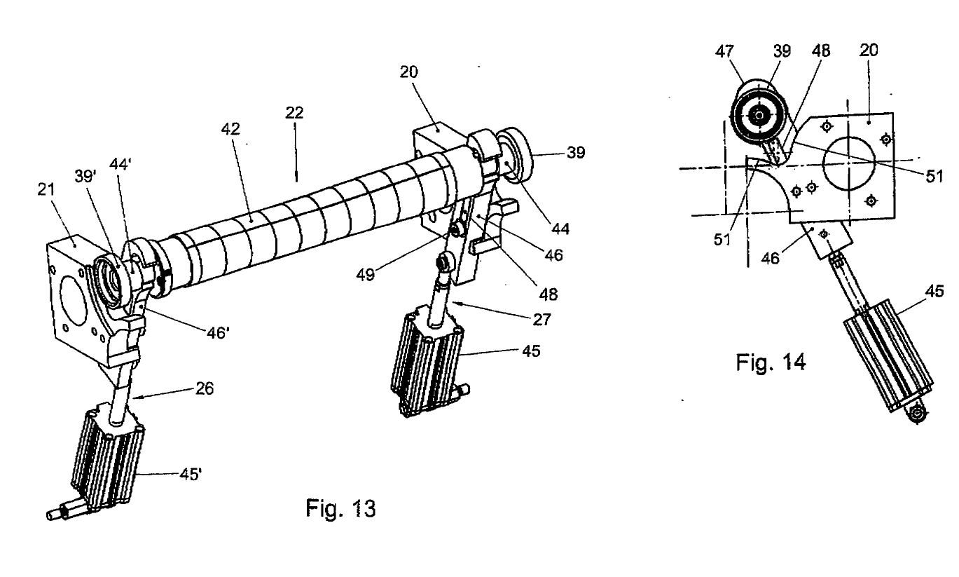

FIG. 13 shows a perspective view of the fixation means with the receiving units, with the plate cylinder assembly in a take-out position;

FIG. 14 shows a side elevation of fixation means with the receiving units and the plate cylinder assembly in a take-out position;

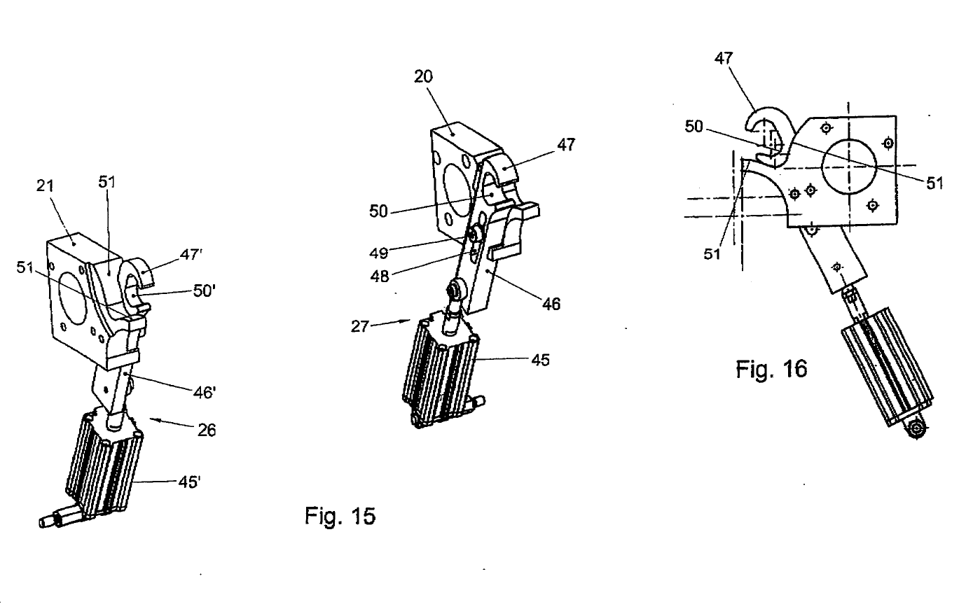

FIG. 15 shows a similar perspective view to FIG. 13, without the plate cylinder assembly;

FIG. 16 shows a similar side elevation to FIG. 14, without the plate cylinder assembly;

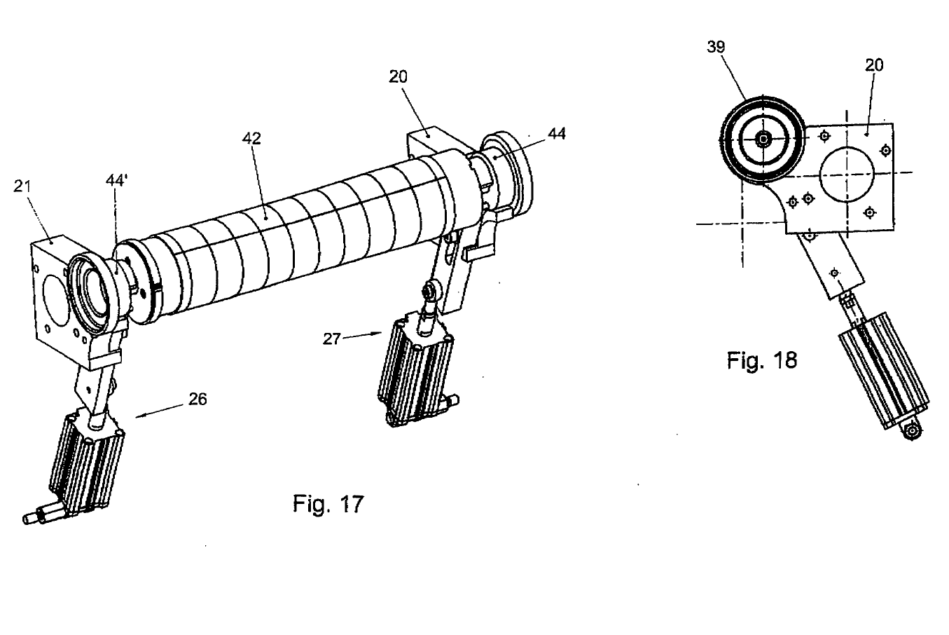

FIG. 17 shows a similar perspective view to FIG. 13, with the plate cylinder assembly in the operative position;

FIG. 18 shows a similar side elevation to FIG. 14, with the plate cylinder assembly in the operative position;

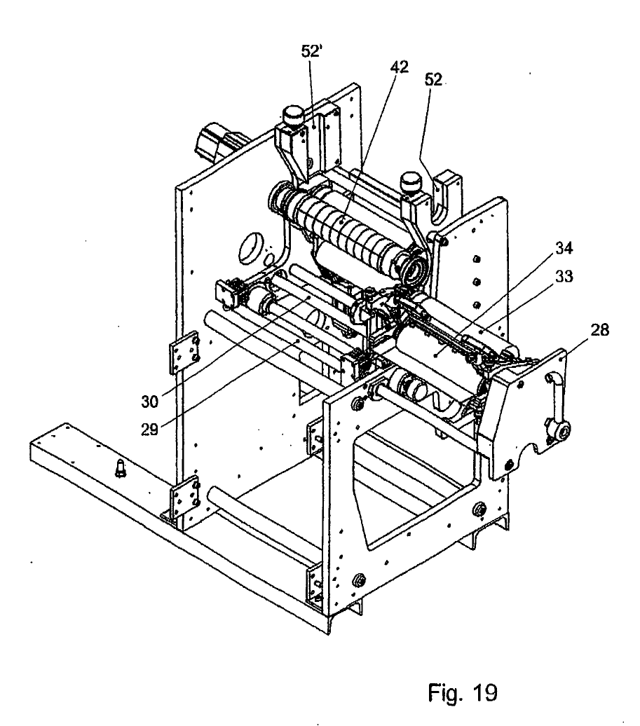

FIG. 19 shows a similar perspective view to FIG. 2, showing the sliding frame with the ink application assembly suspended therein in an outwardly moved position; and

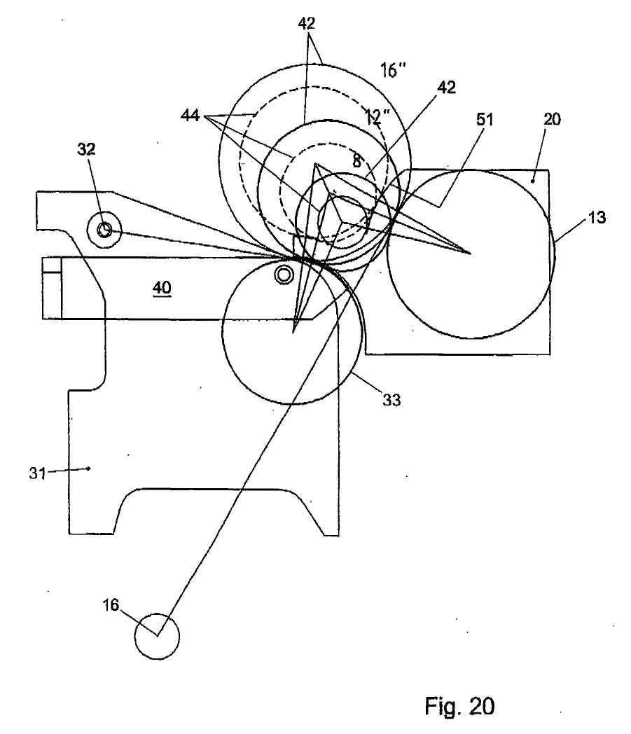

FIG. 20 shows in diagrammatic side view, the receiving units, the impression roller, the second subframe with the anilox roller and three plate cylinder assemblies of different diameters.

The exemplary embodiment of a printing machine 1 represented in FIG. 1 is provided with an unwinding unit 2, a number of printing modules 3-5, and a winding unit 6. Arranged on the upper side of the printing modules is a rails 7 on which additional processing stations can be mounted. Depending on the design end result, the additional processing stations can be placed at different positions on the rails 7. By way of example, the drawing shows a delaminating and relaminating unit 8 for temporarily splitting a self-adhesive substrate web from a certain material web. Further, a web inverting unit 9 is shown, with which the substrate web S can be inverted, for instance for the purpose of printing the other side thereof. Further, a laminating unwinding and winding unit 10 is shown, for the purpose of applying a laminate to the substrate web F, such as for instance hot foil or cold foil. Finally, a matrix winder is provided for winding up waste material after, for instance, labels have been punched out of the substrate web S. FIG. 1 shows the printing modules 3-5 without the ink application means, the plate cylinder and the impression roller. For the build-up of a printing module, reference is made to the description of the following figures.

FIG. 2 shows the main frame 12 of a printing module 3-5. The main frame comprises two main frame plates 12, 12′, which are mutually connected by a number of rods 12a, 12b, 12c and a connecting plate 12d. In the main frame 12, an impression roller 13 is rotatably bearing-mounted. Further, a guide roller 14 is shown, which is also bearing-mounted rotatably in the main frame 12.

FIG. 3 shows the printing module in a condition when it is built up somewhat further. In the main frame 12, presently, a first subframe 15 is included pivotably about pivot 16. For the sake of clarity, FIG. 4 shows the first subframe 15 separately. In FIG. 4 it is clearly visible that the first subframe carries a motor 17 which drives a gearwheel 18. Further, receiving units 20, 21 are fixedly connected with the first subframe 15, in which a plate cylinder assembly 22 (see FIG. 12) is receivable. Also, on the first subframe 15, fixation means 26, 27 are mounted, by means of which the plate cylinder assembly 22 can be fixed in the receiving units 20, 21. The construction and operation of these fixation means will be reverted to later.

The pivoting of the first subframe 15 about the pivot 16 is effected by two piston-cylinder assemblies 23, 24. One end of each of these piston-cylinder assemblies 23, 24 is connected with the main frame 12, while the other end is connected with the first subframe 15. With the piston-cylinder assemblies 28, 24, the pressure can be determined with which the plate cylinder 25 of the plate cylinder assembly 22 is pushed against the impression roll 13.

FIG. 5 shows a sliding frame 28, 28′ mounted slidably in the main frame 12. The sliding frame 28, 28′ is provided with guide rods 29, 30 which are slidably bearing-mounted in the main frame 12. Thus, the sliding frame 28, 28′ can be brought in an extended condition, represented in FIG. 19. The sliding frame 28, 28′ carries a second subframe 31, 31′ which is connected with the sliding frame 28, 28′ so as to be pivotable about pivot points 32, 32′, which is shown in FIG. 6. The sliding frame 28, 28′, apart from the sliding possibility, is otherwise fixedly included in the main frame 12 and may therefore be regarded as forming part of the main frame 12. Accordingly, in the claims reference is made to a second subframe 31, 31′ which is pivotably connected with the main frame 12. This formulation also encompasses the embodiment shown, in which the second subframe 31, 31′ is pivotably connected with the sliding frame 28, 28′, which may be deemed to form part of the main frame 12. It will be clear that in an embodiment that is not provided with a sliding frame 28, 28′, the second subframe 31, 31′ would be directly pivotably connected with the main frame 12. In the second subframe 31, 31′, an anilox roller 33 and a doctor roller 34 are rotatably bearing-mounted. With the aid of piston-cylinder assemblies 35, 36, which are mounted on the main frame 12 (see also FIG. 2), the second subframe 31, 31′ can be pressed in the direction of the plate cylinder assembly 22.

In FIG. 7, the printing module from FIG. 6 is built up still further in that it includes a plate cylinder assembly 22. It is clearly visible that the plate cylinder assembly 22 is freely accessible at the top. To be able to utilize this freely accessible space usefully, above the receiving units 20, 21, receiving means 52, 52′ are provided for mounting additional processing means. The receiving means comprise, in the present exemplary embodiment, two guides 52, 52′. The additional processing means can comprise, for instance, substrate web inverting units, winders, laminating units or the like.

FIG. 8 shows in side elevation the first subframe 15 which carries the plate cylinder assembly 22 and which is pivotable about pivot 16 which is pivotably connected with the main frame 12. The arrows P1 show the direction of movement of the plate cylinder assembly 22 as a result of a pivotal motion of the first subframe 15 about pivot 16. As already indicated above, the pivotal motion is effected by the piston-cylinder assemblies 23, 24, of which in this figure only the specimen 23 is visible. With the pivotal motion, the position of the plate cylinder assembly 22 relative to the impression roller 13 disposed fixedly in the main frame 12 can be controlled. FIG. 8 further shows the second subframe 31 which is pivotable about pivot point 32. Pivoting of the second subframe 31 about pivotal point 32 results in a displacement of the anilox roller 33 in the direction of the arrows P2. With this pivotal motion, therefore, the position of the anilox roller 33 relative to the plate cylinder assembly 22 can be controlled. This positioning is defined in the present exemplary embodiment by a stop 37, 37′, whose operation will be clarified hereinafter.

FIG. 9 shows a perspective view of the sliding frame 28, 28′ and the second subframe 31, 31′ pivotably included therein, with the plate cylinder assembly 22 represented as hanging above the receiving units 20, 21. Also visible is that the anilox roller 33 is fitted in the second subframe 31, 31′. Arranged on the second subframe 31, 31′ are two stops 37, 37′. In the present exemplary embodiment, the position of these stops 37, 37′ can be set relative to the second subframe 31, 31′ with the aid of adjusting screws 38, 38′. The stops 37, 37′ from part of pivoting arms 40, 40′ which are connected with the second subframe 31, 31′ so as to be pivotable about a pivot 41, 41′. The stops 37, 37′ abut against stop surfaces 39, 39′ which are provided on the plate cylinder assembly 22, at least when the plate cylinder assembly 22 is received in the receiving units 20, 21, which is represented in FIGS. 10 and 11. In the present exemplary embodiment, the stop surfaces 39, 39′ are designed as stop rings 39, 39′.

All this is clearly represented in FIG. 12, which shows, in perspective, an exemplary embodiment of a plate cylinder assembly 22. The plate cylinder assembly 22 is provided with a plate cylinder 42 which is rotatable about a stationary shaft 43. Mounted on the stationary shaft 43 are the earlier-mentioned stop rings 39, 39′, as well as supports 44, 44′ in the form of supporting rings 44, 44′ which are received in the receiving units 20, 21.

To set the distance between the anilox roller 33 and the plate cylinder assembly 22, only the adjusting screws 38, 38′ need to be turned. As a result, the second subframe 31, 31′ pivots about the pivot points 32, 32′ and the anilox roller 33 moves relative to the plate cylinder assembly 22. As the position of the anilox roller 33 relative to the plate cylinder assembly 22 is determined by the position of the stops 37, 37′ relative to the second subframe 31, 31′, a displacement of the plate cylinder assembly 22 will have no influence on the relative position of the plate cylinder assembly 22 and the anilox roller 33. In other words, the anilox roller 33 will follow displacements of the plate cylinder assembly 22 in that the stops 37, 37′ are each time pressed against the plate cylinder assembly, more particularly against the stop rings 89, 39′, by the piston-cylinder assemblies 35, 36.

To clarify how the plate cylinder assembly 22 is retained in the receiving units 20, 21, reference is made to FIGS. 13-18. In these figures, in each case, the receiving units 20, 21, fixation means 26, 27 and possibly a plate cylinder assembly 22 are shown. The fixation means 26, 27 are situated substantially under the receiving units 20, 21 and the plate cylinder assembly 22, so that the space above the plate cylinder assembly 22 is freely accessible. The fixation means 26, 27 each comprise a piston-cylinder assembly 45, 45′, which operates a rod 46, 46′, which rod 46, 46′ has a longitudinal centerline in the direction of which the rod 46, 46′ is movable by the respective piston-cylinder assembly 45, 45′. In the present exemplary embodiment, to that end, the rods 46, 46′ are provided with a guide slot 48, in which extends a guide lug 49 which is fixedly connected with the main frame 12. An upwardly directed end of each rod 46, 46′ is provided with a hook 47, 47′. The two hooks 47, 47′ engage, on opposite sides of the plate cylinder 42, the stationary shaft 48 of the plate cylinder assembly 22 when the plate cylinder assembly 22 is in the operative position. In the operative condition, the piston-cylinder assemblies 45, 45′ exert a pull force on the rods 46, 46′, for pressing the plate cylinder assembly 22 into the receiving units 20, 21.

As is clearly visible in FIGS. 15 and 16, the rods 46, 46′ are provided with bearing surfaces 50, 50′ on which rests the plate cylinder assembly 22 when the fixation means 26, 27 are in a release position. The plate cylinder assembly 22 in this release position is lifted out of the receiving units 20, 21 and moved upwards, such that the plate cylinder assembly 22 can be simply taken out of the printing module 3-5. Each bearing surface 50, 50′ upon upward movement of the rods 46, 46′ in the direction of the longitudinal centerlines of the rods automatically enters into engagement with the stationary shaft 43 and thereby lifts the plate cylinder assembly 22 out of the receiving units 20, 21.

The receiving units 20, 21 are each provided with a supporting surface 51, 51′, which is provided with a particular curve. The curve is such that the distance between plate cylinder 42 and the anilox roller 33 on the one hand and the distance between the plate cylinder 42 and the impression roller 13 on the other in each case remain, in pairs, mutually equal at different diameters of plate cylinders 42, which are provided with supports 44, 44′ having diameters matching the plate cylinders 42. In FIG. 20 it is clearly visible what is meant by this. The effect of such a construction of the receiving nuts 20, 21 and circular supporting rings 44, 44′ is that when changing the plate cylinder diameter the distance between the anilox roller 33 and the plate cylinder 44 and the distance between the impression roller 13 and the plate cylinder 42 do not need to be set anew. This yields a considerable saving on the setting time

It will be clear that the invention is not limited to the exemplary embodiment described but that various modifications are possible within the scope of the invention as defined by the claims.

Thus, for instance, instead of a settable stop 37, 37′ on the second subframe 31, 31′, the plate cylinder assembly 22 may be provided with two stop surfaces whose position is settable with respect to the plate cylinder 42.

Further, the second subframe 31, instead of being pivotably connected with the main frame 12, or the sliding frame 28 thereof, could be pivotably connected with the first subframe 15. In such an embodiment, a second piston-cylinder assembly could have a first end connected with the first subframe and by a second end abut against the second subframe, such that with the aid of the second piston-cylinder assembly the second subframe is adjustable relative to the first subframe.

1. A printing module provided with an impression roller, a plate cylinder assembly comprising a plate cylinder which is provided with a print image and which, in use, with interposition of a substrate to be printed, abuts against the impression roller, an anilox roller and a doctor roller, the doctor roller taking up ink from an ink reservoir, the anilox roller being arranged between the doctor roller and the plate cylinder, such that a desired amount of ink is taken off the doctor roller by the anilox roller and transferred to the plate cylinder, the position of the plate cylinder being settable, the position of the anilox roller being settable, and the impression roller being rotatably bearing-mounted in a main frame, characterized in that the plate cylinder is rotatably bearing-mounted in a first subframe which is movably connected with the main frame for the purpose of the positioning of the plate cylinder relative to the impression roller, while the anilox roller and the doctor roller are rotatably bearing-mounted in a second subframe which is movably connected with the main frame for the purpose of the positioning of the anilox roller relative to the plate cylinder, movable connections being so designed that a positioning change of the plate cylinder relative to the impression roller does not affect the positioning of the anilox roller relative to the plate cylinder and that a positioning change of the anilox roller relative to the plate cylinder does not affect the positioning of the plate cylinder relative to the impression roller.

2. A printing module according to claim 1, wherein the plate cylinder assembly is provided with a stop surface, the second subframe being provided with a stop which, in use, abuts against the stop surface of the plate cylinder.

3. A printing module according to claim 2, wherein the position of the stop of the second subframe relative to the second subframe is settable.

4. A printing module according to claim 2, wherein the position of the stop surface on the plate cylinder assembly relative to the plate cylinder assembly is settable.

5. A printing module according to claim 1, wherein the movable connection between the second subframe and the main frame is realized via a movable connection between the second subframe and the first subframe.

6. A printing module according to claim 1, wherein the movable connection between the first subframe and the main frame is a connection pivotable about a first pivot.

7. A printing module according to claim 5, wherein the movable connection between the second subframe and the first subframe is a connection pivotable about a second pivot.

8. A printing module according to claim 1, wherein the movable connection between the second subframe and the main frame is a connection pivotable about a second pivot connected with the main frame.

9. A printing module according to claim 1, provided with a first piston-cylinder assembly which has a first end connected with the main frame and which has a second end connected with the first movable subframe, such that with the aid of the first piston-cylinder assembly the pressure which the plate cylinder exerts in use on the impression roller is settable.

10. A printing module according to claim 1, provided with a second piston-cylinder assembly which has a first end connected with the main frame and which has a second end connected with or abutting against the second subframe, such that with the aid of the second piston-cylinder assembly, the second subframe is adjustable relative to the main frame.

11. A printing module according to claim 2, provided with a second piston-cylinder assembly which has a first end connected with the first subframe and which has a second end connected with or abutting against the second subframe, such that with the aid of the second piston-cylinder assembly, the second subframe is adjustable relative to the first subframe.

12. A printing module according to claim 1, wherein the plate cylinder assembly is provided with a stationary shaft on which the plate cylinder is rotatably bearing-mounted, while on opposite sides of the plate cylinder a stop ring is provided which forms the stop surface and is fixedly connected with the stationary shaft, while on opposite sides of the plate cylinder a supporting ring is fixedly connected with the stationary shaft.

13. A printing module according to claim 12, wherein the first subframe comprises two receiving units disposed on opposite sides of the plate cylinder, in which receiving units rest the supporting rings when the plate cylinder assembly in the operative position is mounted in the printing module.

14. A printing module according to claim 13, wherein the receiving units are each provided with a supporting surface which is provided with a particular curve, the curve being such that the distance between plate cylinder and the anilox roller on the one hand and the distance between the plate cylinder and the impression roller on the other in each case remain pairwise equal to each other at different diameters of plate cylinders, which are provided with supporting rings of diameters matching the plate cylinders.

15. A printing module according to claim 13, wherein fixation means are provided for fixating a plate cylinder assembly in the receiving units, the fixation means being located substantially under the plate cylinder assembly.

16. A printing module according to claim 15, wherein the fixation means comprise two rods which, at an upwardly directed end, are provided with a hook, the two hooks engaging, on opposite sides of the plate cylinder, the stationary shaft of the plate cylinder assembly when the plate cylinder assembly is in the operative position, while on the rods a pull force is exerted for pressing the plate cylinder assembly into the receiving units.

17. A printing module according to claim 16, wherein the two rods, at the ends remote from the hooks, are each connected with a piston-cylinder assembly for adjusting the position of the rods in a longitudinal direction thereof and for exerting said pull force.

18. A printing module according to claim 15, wherein the fixation means are further provided with bearing surfaces on which rests the plate cylinder assembly when the fixation means are in a release position, while the plate cylinder assembly in this release position is lifted out of the receiving units and is moved upwards, such that the plate cylinder assembly can be simply taken out of the printing module.

19. A printing module according to claim 16, wherein each rod is provided with a said bearing surface, which bearing surface upon upward movement of the rods in the direction of the longitudinal axes of the rods automatically enters into engagement with the stationary shaft and thereby lifts the plate cylinder assembly from the receiving units.

20. A printing module according to claim 15, wherein substantially above the receiving units receiving means are provided for mounting additional processing means.

21. A printing module according to claim 20, wherein the receiving means comprise two guides.

22. A printing module according to claim 20, wherein the additional processing means comprise, for instance, substrate web inverting units, winders, laminating units or the like.

23. A printing machine provided with a printing module according to claim 1.
